(19) United States
(12) Patent Application Publication
(10) Pub. No.: US 2009/0039856 A1
(43) Pub. Date: Feb. 12, 2009

(54) Stability enhancement apparatus and method for a self-clocking PWM buck converter

(76) Inventors: Ko-Cheng Wang, Puli Township (TW); Liang-Pin Tai, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,196

(22) Filed: Sep. 28, 2007

(30) Foreign Application Priority Data
Aug. 10, 2007 (TW) 096129657

(51) Int. Cl. G05F 1/44; G05F 1/02

(52) U.S. Cl. 323/285

(57) ABSTRACT

A DCR detecting circuit is parallel connected to the inductor of a self-clocking PWM buck converter which performs a trigger control of a PWM signal by an output feedback, to detect the current signal on the inductor to provide a large enough ripple to be combined into the output feedback, so as to enhance the system stability, while remains the small output ripple, without additional power loss.

### FIELD OF THE INVENTION

The present invention is related generally to power supplies and, more particularly, to a self-clocking pulse width modulation (PWM) buck converter.

### BACKGROUND OF THE INVENTION

In a conventional constant on-time or hysteretic mode self-clocking PWM buck converter, the generation of the PWM signal relies on the output ripple to carry out a trigger control. In this control scheme, ripples that are too small will damage the loop stability while ones that are too large will bring the converter to operate over the specification of the converter. It is a trade-off choice to have a small output ripple and to remain the loop stability.

FIG. 1 shows a conventional constant on-time PWM buck converter. To make it clearer, the equivalent serial resistances (ESR) of the inductor 12 and output capacitor 18 are shown as resistors 14 and 16, respectively. A PWM controller 10 provides PWM signals to switch a high-side switch Q1 and a low-side switch Q2. When the high-side switch Q1 is on and the low-side switch Q2 is off, the inductor current IL charges the output capacitor 18 and the output voltage VOUT increases. When the high-side switch Q1 is off and the low-side switch Q2 is on, the output capacitor 18 discharges and the output voltage VOUT decreases. Resistors 20 and 22 constitute a voltage divider to divide the output voltage VOUT to provide a feedback signal FB for the PWM controller 10, so as to regulate the output voltage VOUT. Ideally, the ripple on the output voltage VOUT is preferred as small as possible. Accordingly, the output capacitor 18 is so designed to have small equivalent resistor 16, for example, using a ceramic capacitor. However, a small output ripple results in a small ripple feedback signal FB, and since the PWM controller 10 uses the ripple of the feedback signal FB to trigger the PWM signal to switch the high-side switch Q1 and the low-side switch Q2, a small ripple feedback signal FB will make the PWM signal easier to be interfered by noises and thus cause the system unstable. FIG. 2 shows the waveforms of the feedback signal FB, the inductor current IL, and the output voltage VOUT when the equivalent resistor 16 is small. As shown, after the load changes, the system becomes unstable and the inductor current IL and the output voltage VOUT diverge. For the PWM controller 10 to trigger the PWM signal more precisely, the ripple of the feedback signal FB needs to be large enough, which is contrary to the need of small ripple for the output voltage VOUT.

In order to stabilize a PWM buck converter and keep the output ripple small, a PWM buck converter is proposed as shown in FIG. 3, in which the output capacitor 18 has a small equivalent resistor 16, and thus the feedback signal FB generated by the voltage divider composed of the resistors 20 and 22 has a too small ripple for the PWM controller 10 to have a good feedback control. However, a resistor 24 and a capacitor 26 is so configured to filter the voltage at the phase node P and couple it to the feedback signal FB to enlarge the ripple of the feedback signal FB. Unfortunately, when the high-side switch Q1 is on, an additional current path is established from the high-side switch Q1 through the resistors 24 and 22 to ground GND, which increases power loss and degrades the efficiency of the converter.

### SUMMARY OF THE INVENTION

One object of the present invention is to reduce the output ripple of a self-clocking PWM buck converter.

Another object of the present invention is to enhance the stability of a self-clocking PWM buck converter.

Still another object of the present invention is to prevent a self-clocking PWM buck converter from additional power loss.

According to the present invention, a direct current resistor (DCR) detecting circuit is parallel connected to the inductor of a self-clocking PWM buck converter which performs a trigger control of a PWM signal by an output feedback, in order to detect the current signal on the inductor to provide a large enough ripple to combine into the output feedback.

With the large enough ripple feedback provided by the DCR detecting circuit, it might remain the system stability together with the small output ripple, without additional power loss.

### BRIEF DESCRIPTION OF DRAWINGS

FIG. 1 shows a conventional constant on-time PWM buck converter;

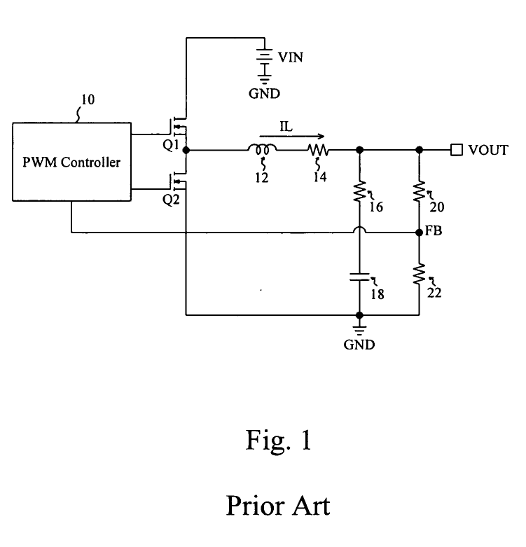

FIG. 2 is a waveform diagram to show the output signal variation when the converter of FIG. 1 suffers a load change;

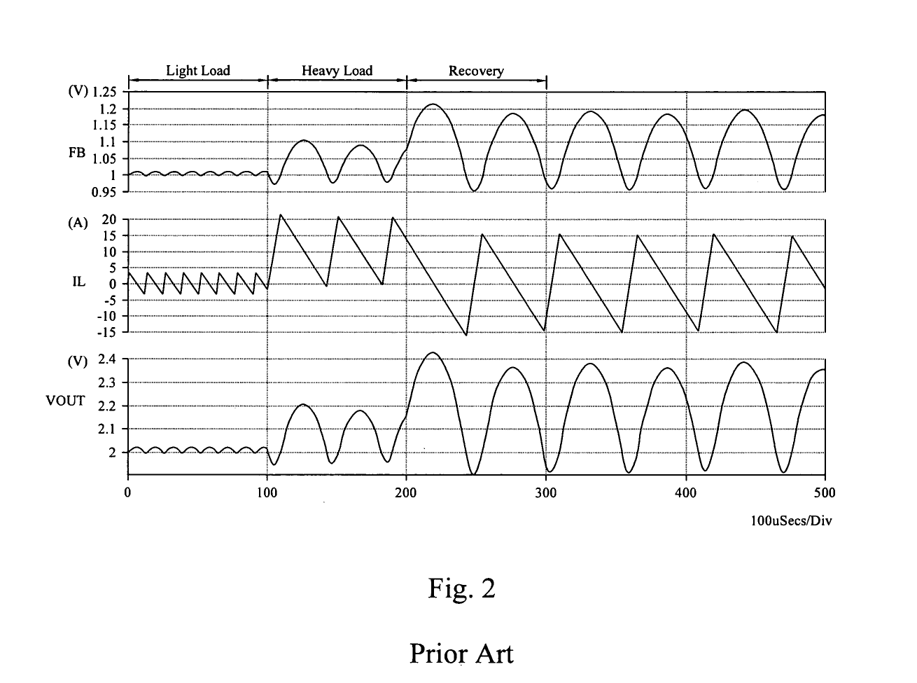

FIG. 3 shows another conventional constant on-time PWM buck converter;

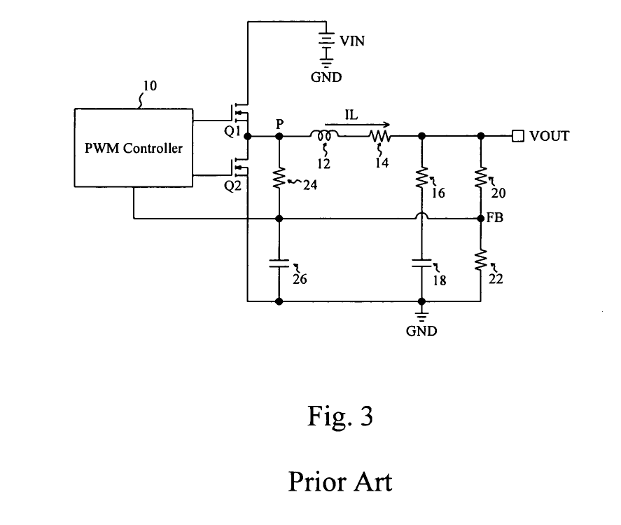

FIG. 4 is a first embodiment according to the present invention;

FIG. 5 is a second embodiment according to the present invention;

FIG. 6 is a waveform diagram obtained by simulation by using the circuit of FIG. 5;

FIG. 7 is a third embodiment according to the present invention; and

FIG. 8 is a waveform diagram obtained by simulation by using the circuit of FIG. 7.

### DETAILED DESCRIPTION OF THE INVENTION

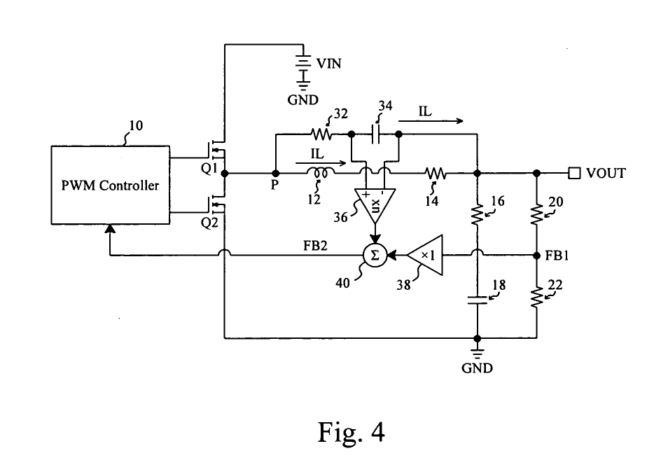

FIG. 4 is a first embodiment according to the present invention, in which the ESR of the output capacitor 18, namely the equivalent resistor 16, is designed so small that the ripple on the output voltage VOUT is small and thus the output voltage VOUT can be regarded as DC voltage. Resistors 20 and 22 constitute a voltage divider to divide the output voltage VOUT to generate a feedback signal FB1 that can be also regarded as DC voltage. The resistor 14 denotes the ESR on the inductor path between the phase node P and the output terminal VOUT. An RC circuit including serially connected resistor 32 and capacitor 34 is parallel connected to the inductor 12, to serve as a DCR detecting circuit, and thus the voltage across the capacitor 34 equals to the voltage across the ESR 14, i.e., the product of the inductor current IL and the resistance of the ESR 14. The voltage across the ESR 14 contains an AC component, which is amplified by an amplifier 36 and by a combiner 40, combined into the feedback signal FB1 buffered by a buffer 38, so as to enlarge the ripple of the feedback signal FB2 provided for the PWM controller 10. Thereupon, the feedback signal FB2 has a larger ripple to enhance the system stability, while the output voltage VOUT remains a rather small ripple.

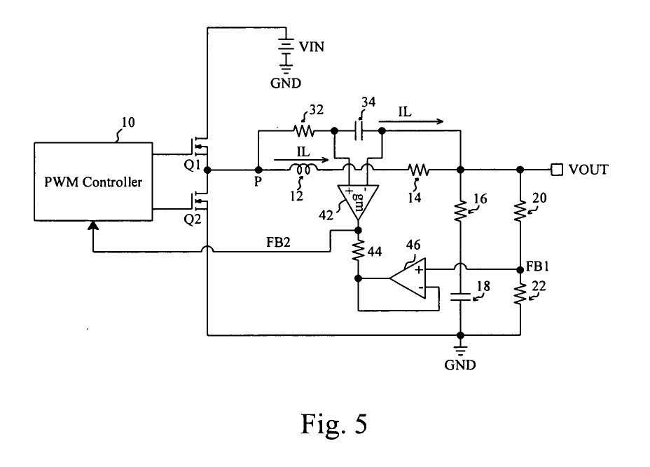

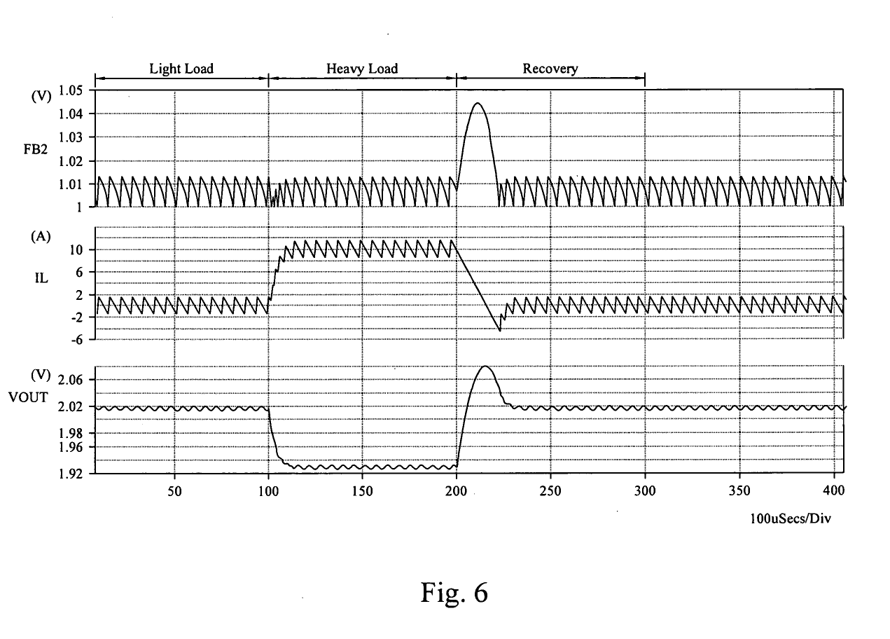

FIG. 5 is a second embodiment according to the present invention, in which a voltage follower 46 has its input to receive the feedback signal FB 1 provided by the divider resistors 20 and 22, and an output terminal coupled to an output terminal of a transconductive amplifier 42 through a resistor 44 having a resistance R, and the transconductive amplifier 42 having a gain gm transforms the voltage across the capacitor 34 to a current flowing through the resistor 44 to generate a voltage to be combined into the feedback signal FB1. If the voltage across the capacitor 34 is VC1, then the feedback signal FB2=VC1×gm×R+FB1, wherein the component (VC1×gm×R) provides the ripple feedback that the system requires for stability. FIG. 6 is a waveform diagram obtained by simulation by the circuit of FIG. 5. As shown, because the equivalent resistor 16 of the output capacitor 18 is very small, the output voltage VOUT has a very small ripple. However, the feedback signal FB2 which has the enlarged ripple still has a ripple large enough to trigger the PWM signal effectively. When the load changes from light to heavy, the output voltage VOUT drops down and the inductor current IL jumps higher, while the feedback signal FB2 still remains a stable ripple. When the heavy load changes back to the light load, the inductor current IL lowers down, and the output voltage VOUT raises up and releases excess charges so that the feedback signal FB2 has a large wave ripple, but it returns to the original level quickly.

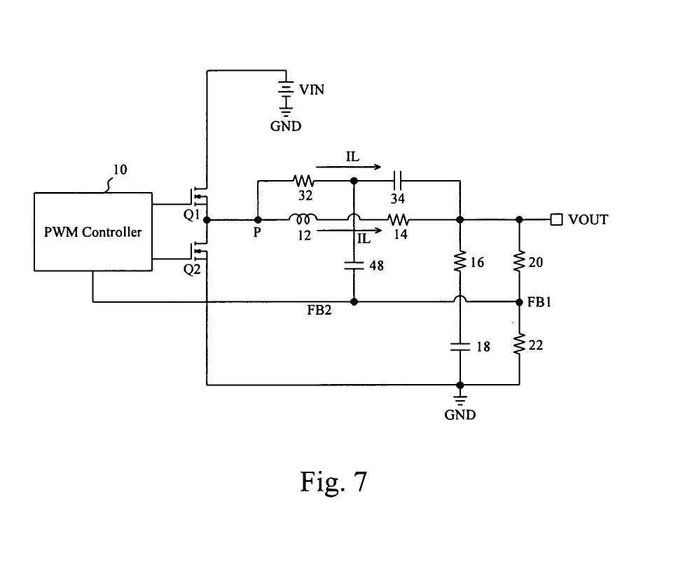

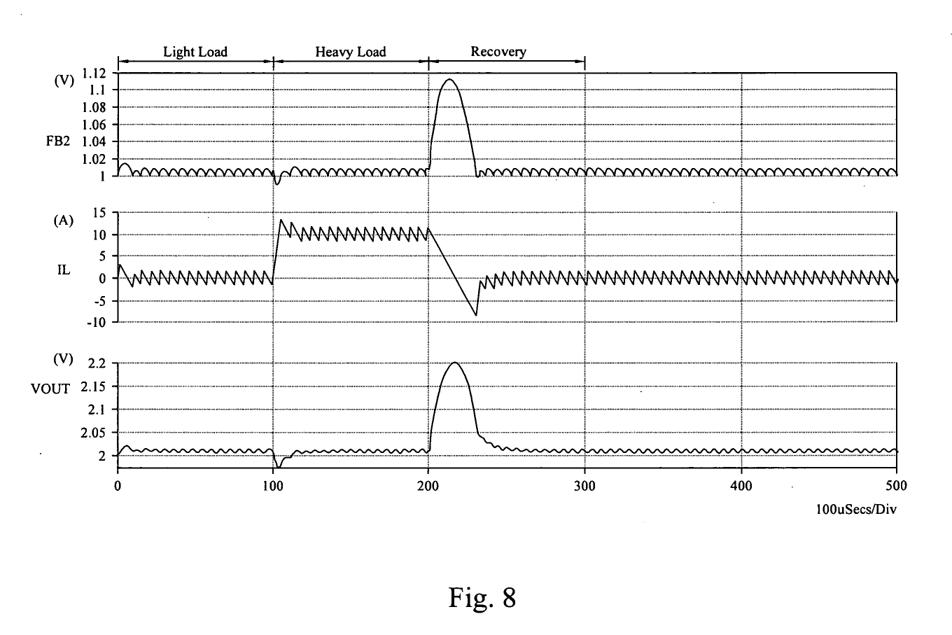

FIG. 7 is a third embodiment according to the present invention, in which the AC signal across the capacitor 34 is directly coupled into the feedback signal FB1 by a capacitor 48, in order to provide enough ripple for system stability, while the output voltage VOUT still has rather small ripple. As shown in FIG. 8, when the load changes from light to heavy, the output voltage VOUT in this embodiment does not drop down significantly, but only lowers slightly and returns to the original level immediately. When the heavy load changes back to the light load, the inductor current IL returns to the original level, and the output voltage VOUT releases excess charges, causing a large ripple and the feedback signal FB2 following accordingly, but the feedback signal FB2 recovers to the original level immediately.

As shown in the above embodiments, the DCR detecting circuit detects the current signal on the inductor to provide enough ripple feedback for system stability, together with the small output ripple, without additional power loss.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A stability enhancement apparatus for a self-clocking PWM buck converter which includes an output stage having an inductor and relies on an output feedback to carry out a trigger control for generation of a PWM signal, the stability enhancement apparatus comprising:
a DCR detecting circuit parallel connected to the inductor for detecting a current signal on the inductor to provide a ripple; and
a circuit for combining the ripple into the output feedback, coupled to the DCR detecting circuit.

2. The stability enhancement apparatus of claim 1, wherein the DCR detecting circuit comprises a serially connected RC circuit parallel connected to the inductor, for extracting the ripple by detecting the voltage across the capacitor of the serially connected RC circuit.

3. The stability enhancement apparatus of claim 1, wherein the circuit for combining the ripple into the output feedback comprises a combiner coupled to the DCR detecting circuit, for adding the ripple to the output feedback.

4. The stability enhancement apparatus of claim 1, wherein the circuit for combining the ripple into the output feedback comprises an amplifier coupled to the DCR detecting circuit, for amplifying the ripple.

5. The stability enhancement apparatus of claim 1, wherein the circuit for combining the ripple into the output feedback comprises a buffer for buffering the output feedback.

6. The stability enhancement apparatus of claim 1, wherein the circuit for combining the ripple into the output feedback comprises a transconductive amplifier coupled to the DCR detecting circuit, for transforming the ripple from a voltage to a current.

7. The stability enhancement apparatus of claim 6, wherein the circuit for combining the ripple into the output feedback further comprises a resistor coupled to an output of the transconductive amplifier, for transforming the ripple from the current to a second voltage.

8. The stability enhancement apparatus of claim 1, wherein the circuit for combining the ripple into the output feedback comprises a voltage follower for introducing the output feedback into the circuit for combining the ripple into the output feedback.

9. The stability enhancement apparatus of claim 1, wherein the circuit for combining the ripple into the output feedback comprises a capacitor coupled to the DCR detecting circuit, for coupling the ripple into the output feedback.

10. A stability enhancement method for a self-clocking PWM buck converter which includes an output stage having an inductor and relies on an output feedback to carry out a trigger control for generation of a PWM signal, the stability enhancement method comprising the steps of:
detecting a current signal on the inductor for providing a ripple; and
combining the ripple into the output feedback.

11. The stability enhancement method of claim 10, wherein the step of detecting a current signal on the inductor for providing a ripple comprises the steps of:
parallel connecting a serially connected RC circuit to the inductor; and
extracting the ripple by detecting the voltage across the capacitor of the serially connected RC circuit.

12. The stability enhancement method of claim 10, wherein the step of combining the ripple into the output feedback comprises the step of adding the ripple to the output feedback.

13. The stability enhancement method of claim 10, further comprising the step of amplifying the ripple.

14. The stability enhancement method of claim 10, further comprising the step of buffering the output feedback.

15. The stability enhancement method of claim 10, wherein the step of combining the ripple into the output feedback comprises the step of transforming the ripple from a voltage to a current.

16. The stability enhancement method of claim 15, further comprising the step of transforming the ripple from the current to a second voltage.

17. The stability enhancement method of claim 10, wherein the step of combining the ripple into the output feedback comprises the step of coupling the ripple into the output feedback by a capacitor.

18. A stability enhanced self-clocking PWM buck converter for generating an output voltage at an output terminal, comprising:
an inductor coupled between a phase node and the output terminal;
an output feedback circuit coupled to the output terminal, for generating a first feedback signal from the output voltage;
a DCR detecting circuit parallel connected to the inductor, for detecting a current signal on the inductor to generate a second feedback signal including a ripple;
a combining circuit coupled to the DCR detecting circuit, for combining the first and second feedback signals to generate a third feedback signal; and
a PWM controller in response to the third feedback signal, for performing a trigger control for generation of a PWM signal.

19. The stability enhanced self-clocking PWM buck converter of claim 18, wherein the output feedback circuit comprises a voltage divider coupled to the output terminal, for dividing the output voltage to generate the first feedback signal.

20. The stability enhanced self-clocking PWM buck converter of claim 19, wherein the voltage divider comprises two resistors connected in serial to the output terminal.

21. The stability enhanced self-clocking PWM buck converter of claim 18, wherein the DCR detecting circuit comprises a serially connected RC circuit parallel connected to the inductor, for generating the second feedback signal by the voltage across the capacitor of the serially connected RC circuit.

22. The stability enhanced self-clocking PWM buck converter of claim 18, wherein the combining circuit comprises an amplifier coupled to the DCR detecting circuit, for amplifying the ripple.

23. The stability enhanced self-clocking PWM buck converter of claim 18, wherein the combining circuit comprises a buffer coupled to the output feedback circuit, for buffering the first feedback signal.

24. The stability enhanced self-clocking PWM buck converter of claim 18, wherein the combining circuit comprises a combiner coupled between the DCR detecting circuit and output feedback circuit, for adding the second feedback signal to the first feedback signal.

25. The stability enhanced self-clocking PWM buck converter of claim 18, wherein the combining circuit comprises a transconductive amplifier coupled to the DCR detecting circuit, for transforming the second feedback signal from a voltage to a current.

26. The stability enhanced self-clocking PWM buck converter of claim 25, wherein the combining circuit further comprises a resistor coupled to an output of the transconductive amplifier, for transforming the second feedback signal from the current to a second voltage.

27. The stability enhanced self-clocking PWM buck converter of claim 18, wherein the combining circuit comprises a voltage follower coupled to the output feedback circuit, for introducing the first feedback signal into the combining circuit.

28. The stability enhanced self-clocking PWM buck converter of claim 18, wherein the combining circuit comprises a capacitor coupled between the DCR detecting circuit and output feedback circuit, for coupling the ripple into the first feedback signal.

29. A method for generating an output voltage at an output terminal by a self-clocking PWM buck converter which includes an output stage having an inductor, the method comprising the steps of:
generating a first feedback signal from the output voltage;
detecting a current signal on the inductor for generating a second feedback signal which includes a ripple;
combining the first and second feedback signals for generating a third feedback signal; and
performing a trigger control in response to the third feedback signal for generation of a PWM signal.

30. The method of claim 29, wherein the step of generating a first feedback signal from the output voltage comprises the step of dividing the output voltage.

31. The method of claim 29, wherein the step of detecting a current signal on the inductor for generating a second feedback signal which includes a ripple comprises the steps of:
parallel connecting a serially connected RC circuit to the inductor; and
generating the second feedback signal by detecting the voltage across the capacitor of the serially connected RC circuit.

32. The method of claim 29, wherein the step of detecting a current signal on the inductor for generating a second feedback signal which includes a ripple comprises the step of amplifying the ripple.

33. The method of claim 29, wherein the step of combining the first and second feedback signals for generating a third feedback signal comprises the step of buffering the first feedback signal.

34. The method of claim 29, wherein the step of combining the first and second feedback signals for generating a third feedback signal comprises the step of adding the second feedback signal to the first feedback signal.

35. The method of claim 29, wherein the step of combining the first and second feedback signals for generating a third feedback signal comprises the step of transforming the second feedback signal from a voltage to a current.

36. The method of claim 35, wherein the step of combining the first and second feedback signals for generating a third feedback signal further comprises the step of transforming the second feedback signal from the current to a second voltage.

37. The method of claim 29, wherein the step of combining the first and second feedback signals for generating a third feedback signal comprises the step of coupling the ripple into the first feedback signal by a capacitor.
